(19) United States
(12) Patent Application Publication
(10) Pub. No.: US 2008/0154657 A1
(43) Pub. Date: Jun. 26, 2008

(54) SYSTEM FOR MONITORING ORDER FULFILLMENT OF TELECOMMUNICATION SERVICES

(75) Inventor: BISHNU NAYAK, SAINT LOUIS, MO (US)

Correspondence Address: AKERMAN SENTERFITT, P.O. BOX 3188, WEST PALM BEACH, FL, 33402-3188, US

(73) Assignee: AT&T KNOWLEDGE VENTURES, LP, RENO, NV (US)

(21) Appl. No.: 11/613,230

(22) Filed: Dec. 20, 2006

(51) Int. Cl. G06Q 10/00

(52) U.S. Cl. 705/7

(57) ABSTRACT

A system for monitoring order fulfillment of telecommunication services is disclosed. An apparatus that incorporates teachings of the present disclosure may include, for example, a monitoring system having a controller element that submits a correlation ID to a service orchestration system (SOS) that manages one or more order fulfillment systems (OFSs) that collectively fulfill a select one of a plurality of telecommunication service orders according to a plurality of intermediate fulfillment steps, receives from the SOS information associated with the plurality of intermediate fulfillment steps tagged with the correlation ID, records said information according to the correlation ID, and collects correlated fulfillment activity for the plurality of telecommunication service orders. Additional embodiments are disclosed.

### FIELD OF THE DISCLOSURE

The present disclosure relates generally to service fulfillment systems, and more specifically to a system for monitoring order fulfillment of telecommunication services.

### BACKGROUND

Telecommunication service providers can segment voice, video and data services in a variety of ways for its subscribers. For example, voice services can be characterized according to calling plans such as domestic, long-distance and international coverage, Voice over IP (VoIP) versus traditional Public Switched Telephone Network (PSTN) voice services, service features such as call waiting, call forwarding, voicemail and so on. Similarly video services such as analog or IPTV can be offered to consumers according to a number of service plans: basic (e.g., national TV networks), standard (e.g., further includes news and child entertainment), premium (e.g., further includes movie channels), and so forth. Data services can be offered according to upload and download data rates, quality of service, and reliability of service.

The number of possible service configurations can be extensive especially when consumers are given flexibility to customize their own service plans. Consequently, when a failure occurs in fulfilling a service requested by a consumer, diagnosing and mitigating the failure can be complex and costly to the service provider.

A need therefore arises for a system for monitoring order fulfillment of telecommunication services.

### BRIEF DESCRIPTION OF THE DRAWINGS

FIG. 1 depicts an exemplary embodiment of a communication system;

FIG. 2 depicts an exemplary method operating in portions of the communication system; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system for monitoring order fulfillment of telecommunication services.

In a first embodiment of the present disclosure, a computer-readable storage medium in a monitoring system can have computer instructions for receiving from a service orchestration system (SOS) a request for a correlation ID to tag steps that fulfill a select one of a plurality of telecommunication service orders, submitting a correlation ID to the SOS for the select one of the plurality of telecommunication service orders, receiving from the SOS information associated with one or more fulfillment steps of the select one of the plurality of telecommunication service orders tagged with the correlation ID, and recording the information associated with said one or more fulfillment steps according to its corresponding correlation ID.

In a second embodiment of the present disclosure, a monitoring system can have a controller element that submits a correlation ID to a service orchestration system (SOS) that manages one or more order fulfillment systems (OFSs) that collectively fulfill a select one of a plurality of telecommunication service orders according to a plurality of intermediate fulfillment steps, receives from the SOS information associated with the plurality of intermediate fulfillment steps tagged with the correlation ID, records said information according to the correlation ID, and collects correlated fulfillment activity for the plurality of telecommunication service orders.

In a third embodiment of the present disclosure, an SOS can have a controller element that receives a correlation ID, tags with the correlation ID fulfillment steps executed by one or more OFSs that collectively fulfill a select one of a plurality of telecommunication service orders, and supplies to a monitoring system information associated with the tagged fulfillment steps of the select one of the plurality of telecommunication service orders for collecting correlated fulfillment activity of the OFSs.

In a fourth embodiment of the present disclosure, an OFS can have a controller element that performs one or more intermediate fulfillment steps associated with a select one of a plurality of telecommunication service orders as directed by an SOS, wherein the SOS supplies to a monitoring system information associated with the fulfillment steps tagged with a correlation ID, and wherein the monitoring system collects correlated fulfillment activity of the OFS from additional fulfillment cycles directed by the SOS.

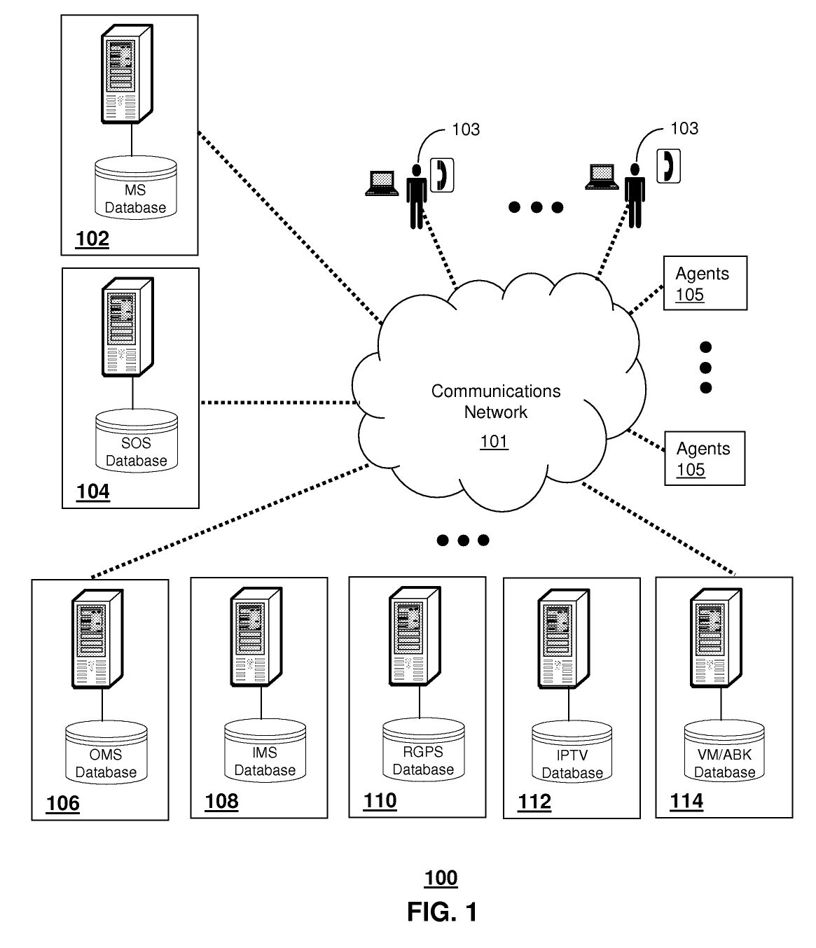

FIG. 1 depicts an exemplary embodiment of a communication system 100. The communication system 100 can comprise a monitoring system (MS) 102, coupled to a service orchestration system (SOS) 104 that manages one or more order fulfillment systems (OFSs) 106-114. The OFSs can comprise, for example, an order management system (OMS) 106, an IP Multimedia Subsystem (IMS) 108, a residential gateway provisioning system (RGPS) 110, an IPTV system 112, and a voicemail/address book (VM/ABK) system 114. Although shown as single computing systems, the OFSs 106-114 can be represented as centralized or decentralized computing devices. Other telecommunication systems not described herein that can operate as an OFS for the purpose of fulfilling in whole or in part a telecommunication service order can also be applied to the present disclosure.

The OMS 106 can be utilized by agents 105 of the communication system 100 to establish telecommunications service orders submitted by a prospective customer 103. The IMS 108 can be utilized as one element in the fulfillment process. For example, the IMS 108 can be used for fulfilling a request for a Voice over IP (VoIP), or other types data services by provisioning the appropriate network elements (e.g., routers, media gateways, switches, etc.) of a communications network 101 that supports wireline and/or wireless communication technologies. The RGPS 110 can be utilized for device provisioning (e.g., a VoIP terminal of the customer 103). The IPTV 112 system can be utilized for provisioning common IPTV services. The VM/ABK system 114 can be used for provisioning voicemail services for the customer as well as address book (or contact book) services. It will be appreciated that the VM/ABK system 114 can also be represented in FIG. 1. as independently operated systems. The SOS 104 can be programmed with all possible combinations of possible telecommunication service orders. Accordingly, when a telecommunications service order is generated by the OMS 106 in response to a customer request it is submitted to the SOS which thereafter orchestrates the fulfillment of said order by way of one or more of the OFSs 106-114 collectively.

The SOS 104 and the aforementioned OFSs 106-114 can utilized centralized or decentralized common computing technologies (e.g., desktop computers, servers, mainframes, etc.). Moreover, one or more of said devices 104-114 can be combined into a single or multiple computing devices. Accordingly, the illustrations of FIG. 1 can be considered logical representations for the purposes of the present disclosure.

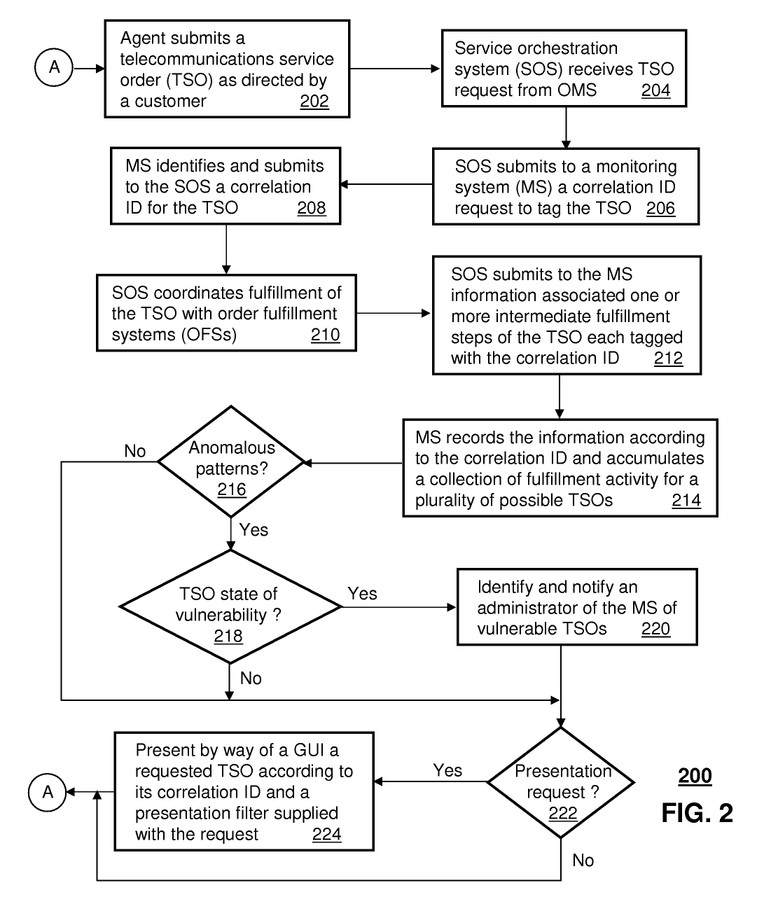

FIG. 2 depicts an exemplary method 200 operating in portions of the communication system 100. Method 200 begins with step 202 in which an agent 105 submits a telecommunications service order (TSO) as directed by a customer 103. In response to the SOS 104 receiving the requested TSO from the OMS 106 in step 204, the SOS can submit to the MS 102 in step 206 a request for a correlation ID for tagging and thereby tracking each of the fulfillment steps to complete the requested TSO. In step 208, the MS 102 identifies a unique correlation ID for the requested TSO and submits said ID to the SOS 104. The SOS 104 thereafter coordinates the fulfillment process with the OFSs 106-114 in step 210 to complete the requested TSO.

In step 212, the SOS 104 submits to the MS 102 information associated with one or more intermediate fulfillment steps required for completing the requested TSO. Said steps are each tagged with the correlation ID given in step 208 and each step can be further tagged with a time stamp for diagnostic purposes. Intermediate fulfillment steps can represent as much fulfillment process detail as is made available by the SOS 104 and the corresponding OFSs 106-114 it manages.

For instance, an intermediate fulfillment step can represent a request submitted by the SOS 104 to one of the OFSs 106-114 to complete a fulfillment task (e.g., SOS 104 submits VoIP provisioning request to IMS 108) followed by a response by the select OFS in fulfilling said task (e.g., IMS responds with an indication that the request was fulfilled or could not be fulfilled with perhaps information indicating why). Each of these process fulfillment steps can be time stamped according to its start and/or end times and is tagged with the correlation ID for reconstruction and/or analysis by the MS 102. Alternatively, or in combination with the foregoing embodiment, an intermediate fulfillment step can represent a number of fulfillment processes executed at the select OFS. In this latter embodiment, the SOS 104 can collect information associated with said processes (e.g., network elements provisioned, responses from said network elements, etc.), time stamp each process, and tag said processes with the correlation ID.

It should be noted that the SOS 104 can be programmed in step 212 to submit to the MS 102 the fulfillment information as it comes from the OFSs 106-114 in near real-time, or the SOS can collect said information from the OFSs and then submit it to the MS at a point in time after the requested TSO has been fulfilled.

In either case, the MS 102 records in step 214 the information supplied by the SOS 104 in its database according to the correlation ID tagged with said TSO. As method 200 is repeated over many cycles for each TSO request created in step 202, the MS 102 accumulates a collection of fulfillment activity for all possible TSOs managed by the SOS 104. In a supplemental embodiment, the MS 102 can be programmed in step 216 to analyze the collection of fulfillment activity for anomalous patterns utilizing common statistical techniques such as regression or other pattern recognition algorithms. If no anomalous patterns are detected, the MS 102 proceeds to step 222 where it checks for a presentation request from an administrator of the MS. If none is requested, method 200 is repeated beginning with step 202.

If, on the other hand, an anomalous pattern is detected, the MS 102 proceeds to step 218 where it can determine if a fulfillment state of vulnerability is present for any of the possible TSOs managed by the SOS 104. A vulnerability step can represent a failure in the fulfillment process of a select TSO or a potential for failure given the performance characteristics analyzed by the MS 102 from the collection of fulfillment activity. To detect potential failures, TSO profiles can be utilized in step 218 by the MS 102. TSO profiles can dictate, for example, expected behaviors for each TSO such as an expected duration time for completing each intermediate fulfillment step of a select TSO. If the duration time is exceeded more than a given number of times at a given hour, day, week or month, the MS 102 can be programmed to flag the intermediate fulfillment step(s) failing to satisfy the duration times given, identify affected TSOs by correlation ID, and so on. In step 220 the MS 102 can utilize the analysis of step 218 to identify and notify an administrator of the MS of the vulnerable TSOs identified by their corresponding correlation ID. If desired, the notification can further identify the intermediate fulfillment steps causing the vulnerability in each of the affected TSOs.

With the correlation IDs of the affected TSOs known, the administrator can request in step 222 presentation of an affected TSO in step 224 by way of one or more graphical user interfaces (GUIs) depicted on a display of the MS 102. The GUIs can, for example, depict a flow diagram for a select TSO, the intermediate fulfillment steps at each of the OFSs 106-114, and telemetry information associated therewith (e.g., start time, end and duration times for the fulfillment steps, etc.). The GUIs can also graphically highlight portions of the TSO flow diagram (e.g., flashing intermediate fulfillment links, flashing OFS blocks, etc.) causing the alleged vulnerability.

Referring back to step 216, if there are no anomalous patterns detected, but the administrator of the MS 102 desires to view one or more TSOs, the MS proceeds from step 222 to step 224 where said TSO can be viewed according to a presentation filter included in the request. The presentation filter can created by a GUI interface presented to the administrator at the MS 102. Aspects of the presentation filter can include a temporal parameter for presenting a temporal range of the retrieved information associated with the selected TSO(s). In this embodiment, the selected TSO can be identified by its correlation ID in which case the information retrieved is customer specific. Alternatively, the correlation ID can include a wildcard character for selecting a TSO category rather than a specific customer's TSO. In this embodiment, fulfillment information associated with the select TSO category can be presented in summary form. For example, summary data can be presented for the number of successfully and unsuccessfully fulfilled TSOs of a given TSO category. As described earlier in step 220, the MS 102 can also be programmed to identify the vulnerable TSOs and their corresponding vulnerability steps using common GUI highlighting techniques.

Method 200 as presently described provides administrators the means to comprehensively monitor operations of the SOS 104 and the OFSs 106-114. An administrator can readily determine where a failure has occurred or may occur based on vulnerability patterns detected by the MS 102. Accordingly, an administrator can take corrective actions to mitigate failures or possible failures and thereby improve operations of the communication system 100 and overall customer satisfaction of the services provided by said system.

Upon reviewing the aforementioned disclosure, it would be evident to an artisan with ordinary skill in the art that the aforementioned embodiments can be modified, reduced, or enhanced without departing from the scope and spirit of the claims described below. For example, steps 216-220 of method 200 can be removed thereby placing the burden on the administrator to detect anomalous operations. Other present and future techniques can be applied to the present disclosure for detecting anomalous patterns and states of vulnerability for each of the possible TSOs managed by the SOS 104. It should be apparent by these examples that several modifications can be applied to the present disclosure without departing from the scope of the claims stated below. Accordingly, the reader is directed to the claims section for a fuller understanding of the breadth and scope of the present disclosure.

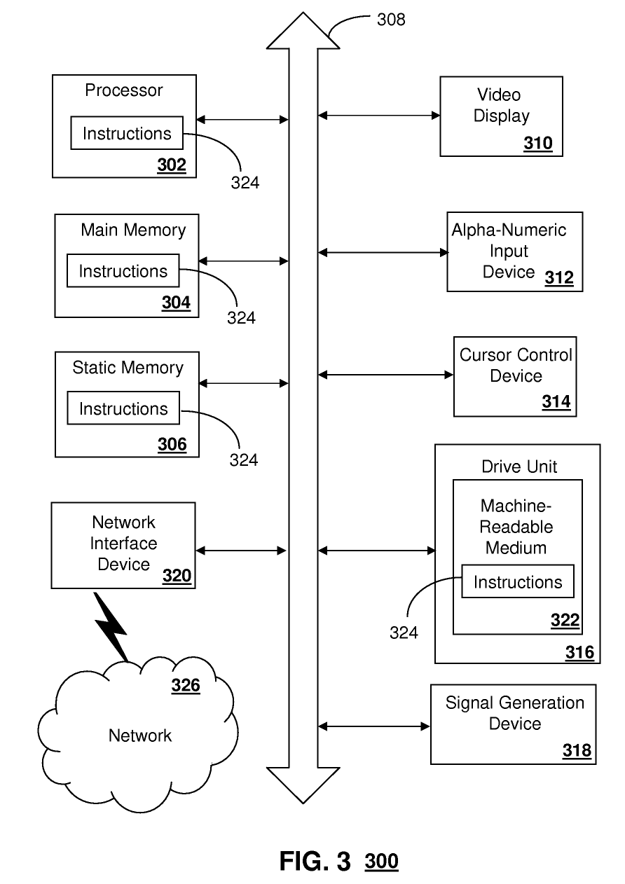

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a monitoring system, comprising computer instructions for:
receiving from a service orchestration system (SOS) a request for a correlation ID to tag steps that fulfill a select one of a plurality of telecommunication service orders;
submitting a correlation ID to the SOS for the select one of the plurality of telecommunication service orders;
receiving from the SOS information associated with one or more fulfillment steps of the select one of the plurality of telecommunication service orders tagged with the correlation ID; and
recording the information associated with said one or more fulfillment steps according to its corresponding correlation ID.

2. The storage medium of claim 1, comprising computer instructions for repeating the foregoing steps thereby accumulating a collection of fulfillment activity for the plurality of telecommunication service orders.

3. The storage medium of claim 1, comprising computer instructions for:
receiving a request for presenting in whole or in part the collection of fulfillment activity according to one or more correlation IDs included in the request;
retrieving information associated with one or more intermediate fulfillment steps of a corresponding one or more telecommunication service orders from the collection of fulfillment activity according to the one or more correlation IDs; and
presenting a graphical user interface (GUI) corresponding to the retrieved information.

4. The storage medium of claim 3, wherein the request for presentation comprises a presentation filter, and wherein the storage medium comprises computer instructions for presenting the GUI according to the presentation filter.

5. The storage medium of claim 4, wherein the presentation filter comprises at least one among a temporal parameter for presenting a temporal range of the retrieved information, a number of successfully fulfilled orders determined from the collection of fulfillment activity having the same or similar intermediate fulfillment steps as the one or more telecommunication service orders associated with the one or more correlation IDs, a number of unsuccessfully fulfilled orders determined from the collection of fulfillment activity having the same or similar intermediate fulfillment steps as the one or more telecommunication service orders associated with the one or more correlation IDs, and an identification given to the one or more intermediate fulfillment steps experiencing a fault.

6. The storage medium of claim 1, comprising computer instructions for detecting one or more anomalous patterns in the collection of fulfillment activity.

7. The storage medium of claim 6, comprising computer instructions for detecting from the one or more anomalous patterns one or more of the plurality of telecommunication service orders each having a fulfillment state of vulnerability.

8. The storage medium of claim 7, comprising computer instructions for identifying one or more steps for each of the detected telecommunication service orders causing in whole or in part the fulfillment state of vulnerability according to one or more associated TSO profiles.

9. The storage medium of claim 8, comprising computer instructions for:
notifying an end user of the vulnerability; and
presenting in response to a request by the end user at least one GUI depicting the one or more steps for each of the detected telecommunication service orders causing the corresponding fulfillment state of vulnerability.

10. The storage medium of claim 1, wherein the information associated with said one or more steps corresponds to processing information for each of one or more order fulfillment systems (OFSs) managed by the SOS.

11. The storage medium of claim 1, wherein each of the plurality of telecommunication service orders comprise at least one among voice, video and data service components.

12. A monitoring system, comprising a controller element that submits a correlation ID to a service orchestration system (SOS) that manages one or more order fulfillment systems (OFSs) that collectively fulfill a select one of a plurality of telecommunication service orders according to a plurality of intermediate fulfillment steps, receives from the SOS information associated with the plurality of intermediate fulfillment steps tagged with the correlation ID, records said information according to the correlation ID, and collects correlated fulfillment activity for the plurality of telecommunication service orders.

13. The monitoring system of claim 12, wherein the controller element collects the correlation fulfillment activity according to a plurality of iterations of the foregoing steps.

14. The monitoring system of claim 12, wherein the controller element receives a request for presenting in whole or in part the collection of correlated fulfillment activity according to one or more correlation IDs included in the request.

15. The monitoring system of claim 14, wherein the controller element presents a graphical user interface (GUI) for information associated with one or more intermediate fulfillment steps of a corresponding one or more telecommunication service orders retrieved from the collection of correlated fulfillment activity according to the one or more correlation IDs.

16. The monitoring system of claim 14, wherein the request for presentation comprises a presentation filter, and wherein the controller element presents the GUI according to the presentation filter.

17. The monitoring system of claim 16, wherein the presentation filter comprises at least one among a temporal parameter for presenting a temporal range of the retrieved information, a number of successfully fulfilled orders determined from the collection of fulfillment activity having the same or similar intermediate fulfillment steps as the one or more telecommunication service orders associated with the one or more correlation IDs, a number of unsuccessfully fulfilled orders determined from the collection of fulfillment activity having the same or similar intermediate fulfillment steps as the one or more telecommunication service orders associated with the one or more correlation IDs, and an identification given to the one or more intermediate fulfillment steps experiencing a fault.

18. The monitoring system of claim 12, wherein the controller element detects one or more anomalous patterns in the collection of fulfillment activity.

19. The monitoring system of claim 18, wherein the controller element detects from the one or more anomalous patterns one or more of the plurality of telecommunication service orders each having a fulfillment state of vulnerability, and identifies one or more steps of each of the detected telecommunication service orders causing in whole or in part the fulfillment state of vulnerability.

20. The monitoring system of claim 12, wherein the controller element time stamps the collected correlated fulfillment activity.

21. A service orchestration system (SOS), comprising a controller element that receives a correlation ID, tags with the correlation ID fulfillment steps executed by one or more order fulfillment systems (OFSs) that collectively fulfill a select one of a plurality of telecommunication service orders, and supplies to a monitoring system information associated with the tagged fulfillment steps of the select one of the plurality of telecommunication service orders for collecting correlated fulfillment activity of the OFSs.

22. An order fulfillment system (OFS), comprising a controller element that performs one or more intermediate fulfillment steps associated with a select one of a plurality of telecommunication service orders as directed by a service orchestration system (SOS), wherein the SOS supplies to a monitoring system information associated with the fulfillment steps tagged with a correlation ID, and wherein the monitoring system collects correlated fulfillment activity of the OFS from additional fulfillment cycles directed by the SOS.

23. The OFS of claim 22, wherein each fulfillment cycle comprises at least one intermediate fulfillment step performed by the OFS and other OFSs directed by the SOS for enabling service according to one among the plurality of telecommunication service orders.
